(19) United States
(12) Patent Application Publication
(10) Pub. No.: US 2025/0060928 A1
(43) Pub. Date: Feb. 20, 2025

(54) TRIGGERING DIVIDED SCREEN MODES FOR COMPANION GENERATIVE AI APPLICATIONS IN MOBILE DEVICES

(71) Applicant: Google LLC, Mountain View, CA (US)

(72) Inventor: Arash Sadr, Belmont, CA (US)

(21) Appl. No.: 18/235,148

(22) Filed: Aug. 17, 2023

(51) Int. Cl. G06F 3/14; G06F 1/16; G06F 3/04842; H04M 1/02

(52) U.S. Cl. CPC G06F 3/1454; G06F 1/1652; G06F 3/04842; G06F 3/1423; H04M 1/0268; G06F 2203/04803

(57) ABSTRACT

Techniques involve triggering a divided screen mode for a computing environment in response to an indication that a display aspect of the computing environment has changed. In a first portion of the divided screen mode, an interface for a main application is displayed; in a second portion of the divided screen mode, an interface for a companion application is displayed. In some implementations, prior to the interface for the companion application being displayed, an icon representing the companion application is displayed in the second portion; the user may point to, or click on, the icon to launch the companion application.

### TECHNICAL FIELD

This description relates in general to using generative AI models in mobile devices.

### BACKGROUND

Generative artificial intelligence (GAI) applications have rapidly come into use in many software platforms, such as large language models (LLMs) used in conjunction with search applications. For example, a user may take a photograph of an object with which the user is not familiar. The user may then use the photograph in a LLM-enabled search application to get information about the object. As other examples, GAI can be used to generate images from a user prompt or provide conversational-type responses to a user prompt.

### SUMMARY

This improvement is directed to a companion application that provides generative AI assistance for various applications (e.g., search, social media, productivity tools) and that is triggered under certain conditions. For example, the companion application may be configured to perform generative artificial intelligence (GAI), including large language model (LLM) operations, in service to an application, such as a search application, an operating system, a document production application (e.g., formatted text document, a spreadsheet, a slide presentation document, etc.), a browser, etc., referred to as a main application. The companion application can be triggered in a variety of ways, depending on the form factor of the device. For example, in a foldable smartphone device, when a user unfolds the phone, a selectable icon can be surfaced and, in response to user selection of the icon, the screen may be divided with the companion application running in a portion of the divided screen. Folding the phone may remove the companion application user interface. Similarly, if a display is rotated from portrait mode to landscape mode the selectable icon can be surfaced, with a rotation back to portrait mode removing the companion application user interface. As another example, the selectable icon may be surfaced in response to a user bringing a first device near (proximate to) a second device, e.g., such as bringing a smart watch, smart glasses, or a smart phone near a tablet or laptop. In such an implementation, selection of the icon may open the companion application on the first device. Surfacing the selectable icon to launch the companion application reduces user input to find and launch the companion application. Additionally, because the companion application takes display real estate away from the main application, implementations intelligently surface the selectable icon for the companion application; e.g., surfacing the selectable icon where there the display aspect has changed. A change in the display aspect includes a changed in width of the display area, e.g., unfolding the phone, rotation to landscape mode, bringing a first device near a second device. In some implementations, the selectable icon is optional and in such implementations the companion app may automatically open in a portion of the divided screen.

In one general aspect, a method includes receiving an indication that a display aspect of a computing environment has changed, the computing environment including a display of a main application. The method also includes, in response to the indication, triggering a divided screen mode for the computing environment, the divided screen mode including a first portion and a second portion. The method further includes displaying an interface for the main application in the first portion. The method further includes displaying an interface for a companion application in the second portion.

In another general aspect, a computer program product comprising a nontransitive storage medium, the computer program product including code that, when executed by processing circuitry, causes the processing circuitry to perform a method. The method includes receiving an indication that a display aspect of a computing environment has changed, the computing environment including a display of a main application. The method also includes, in response to the indication, triggering a divided screen mode for the computing environment, the divided screen mode including a first portion and a second portion. The method further includes displaying an interface for the main application in the first portion. The method further includes displaying an interface for a companion application in the second portion.

In another general aspect, an electronic apparatus includes memory and processing circuitry coupled to the memory. The processing circuitry is configured to receive an indication that a display aspect of a computing environment has changed, the computing environment including a display of a main application. The processing circuitry is also configured to, in response to the indication, trigger a divided screen mode for the computing environment, the divided screen mode including a first portion and a second portion. The processing circuitry is further configured to display an interface for the main application in the first portion. The processing circuitry is further configured to display an interface for a companion application in the second portion.

The details of one or more implementations are set forth in the accompanying drawings and the description below. Other features will be apparent from the description and drawings, and from the claims.

### BRIEF DESCRIPTION OF THE DRAWINGS

FIGS. 1A-1C are diagrams that illustrate an example triggering of a divided screen mode in a foldable phone, in accordance with implementations described herein.

FIGS. 2A-2C are diagrams that illustrate an example triggering of a divided screen mode in a mobile device, in accordance with implementations described herein.

FIGS. 3A-3C are diagrams that illustrate an example triggering of a divided screen mode in a mobile device via a desktop computer, in accordance with implementations described herein.

FIG. 4 is a diagram that illustrates an example electronic environment for performing the implementations described herein.

FIG. 5 is a flow chart illustrating an example method for triggering a companion application in a device, in accordance with the implementations described herein.

### DETAILED DESCRIPTION

Generative artificial intelligence (GAI) has rapidly come into use in many software platforms. As one example, GAI used in large language models (LLMs) can be integrated with a search application.

A technical problem with GAI applications is that such applications are not necessarily integrated into the software applications with which they work. Accordingly, using them in conjunction with separate software applications can be difficult on a device. For example, a user may wish to use the output of a GAI module with another application but it is difficult to do so because the user must close out of the other application in order to use the GAI output.

At least one technical solution to the above technical problem is directed to triggering a divided screen mode for a computing environment in response to an indication that a display aspect of the computing environment has changed. In a first portion of the divided screen mode, an interface for a main application is displayed; in a second portion of the divided screen mode, an interface for a companion application is displayed. In some implementations, prior to the interface for the companion application being displayed, an icon representing the companion application is displayed in the second portion; the user may point to, or click on, the icon to launch the companion application.

In the context of the technical solution, the companion application is the application providing GAI features, while the main application involves other, non-GAI features. In some implementations, the main application provides input for the companion application. For example, a camera application provides a photograph for input into a GAI companion application. In some implementations, the companion application provides input for the main application. For example, a GAI-enabled search application may generate a search result for input into a map application.

A technical advantage of the technical solution is that the user does not need to close out of the main application in order to use a companion application. Rather, the interfaces for both applications may be viewed simultaneously by the user.

Another technical problem with GAI functionality is that the user interface (e.g., the prompt interface especially for a conversational LLM) can occupy a large area of the display, making it difficult for a user to use/view the main application's interface. Intelligent surfacing of the companion application based on a change in the display aspect provides a technical solution that minimizes interruption of the main application's interface. Triggering the companion application based on a change in the display aspect provides a better experience for the user because the change in display aspect enables the system to provide the companion application interface with the main application interface as it appeared before the change in display aspect. Put another way, when the display aspect changes, the interface of the main application can be moved into the first portion of the divided screen, leaving the second portion of the divided screen for the companion application. This intelligent surfacing reduces user input needed to utilize the companion application while minimizing disruption of the main application.

In one instance a person may wish to perform a search for an object that does not exist yet; the person may unfold a foldable smart phone currently executing a search application (e.g., a search web application running in a browser tab, etc.), which surfaces the selectable icon. In response to selection of the icon, the companion application may open in one portion of the unfolded display, enabling the person to describe the object to the companion application (e.g. via a text or voice prompt), which description causes the companion application to generate an image of the object. The companion application then provides the image to the search application running concurrently with the companion application. In another instance, a person currently executing a word processing application may desire to summarize a meeting. The person can rotate a tablet (or bring their phone close to a laptop, etc.), which cause a companion app to open along with the word processing application. The person can ask (e.g., via a prompt) the companion to analyze a recording of the meeting and input a meeting summary into a word processing application. The companion application can bring generative AI assistance to any application.

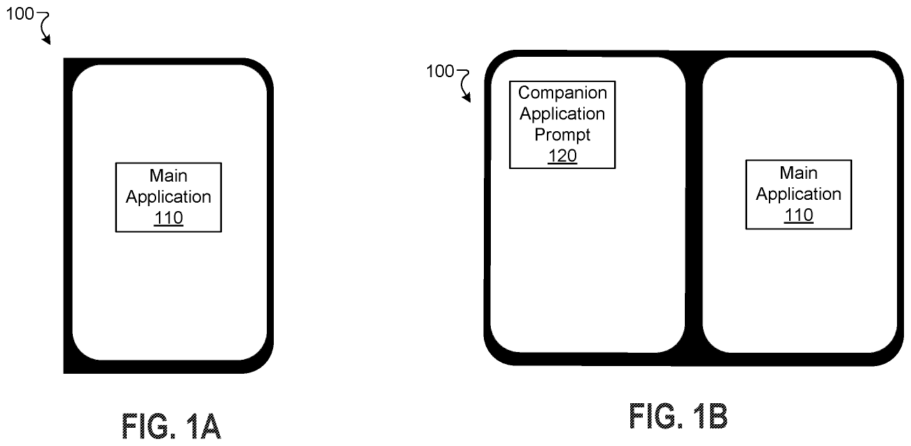

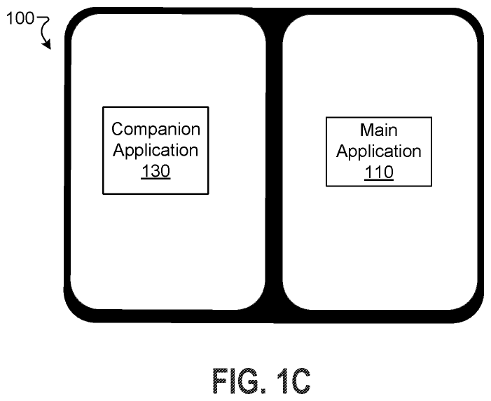

FIGS. 1A-1C are diagrams that illustrate an example triggering of a divided screen mode in a foldable device 100. The foldable device 100 is a mobile device that operates in two modes: folded and open. When the foldable device 100 is unfolded to the open mode, the aspect ratio of the foldable device 100 changes based on the foldable device 100 transitioning from the folded mode to the open mode. In a folded mode as shown in FIG. 1A, the foldable device 100 may have an aspect ratio typical of a mobile device. The aspect ratio of a typical mobile device has a limited display area. In this folded mode, the foldable device 100 may display a main application or a companion application, but may not display the full interface of both at once. In FIG. 1A, the foldable device 100 is displaying the full interface of main application 110 in the folded mode.

FIG. 1B is a diagram that illustrates the foldable device 100 in the open mode. When the foldable device 100 was unfolded, an indication of the change from the folded mode to the open mode was sent to processing circuitry of the foldable device 100. Changing from a folded mode to an open mode is an example of a change in a display aspect. Upon receipt of the indication, the processing circuitry may trigger a divided screen mode for the foldable device 100. In some implementations, the division is at the fold of the foldable device 100. On a first portion of the divided screen mode, an interface for the main application 110 is displayed. On a second portion of the divided screen mode, a selectable control, e.g., a prompt 120 for the companion application, is displayed. In some implementations, the prompt 120 takes the form of an icon that, when selected by the user, launches the companion application 130 in the second portion, i.e., displays a prompt interface for the companion application 130 in the second portion. In some implementations, the prompt 120 is the prompt interface. A prompt interface for the companion application 130 includes an input field (e.g., a text input box, a file drag-and-drop location, etc.) where the user can provide a prompt for the model associated with the companion application 130.

FIG. 1C is a diagram that illustrates the foldable device 100 in the open mode, but with the prompt 120 having been replied to. Accordingly, the foldable device 100 is in the divided screen mode with the first portion displaying an interface for the main application 110 and the second portion displaying an interface for the companion application 130.

In some implementations, the companion application 130 is configured to generate an output that can be provided to the main application 110 as an input. In some implementations, the companion application runs as part of an operating system under which the main application 110 runs. In some implementations, the companion application 130 may be closed or sent to the background in response to the device 100 being changed from the open mode to the folded mode.

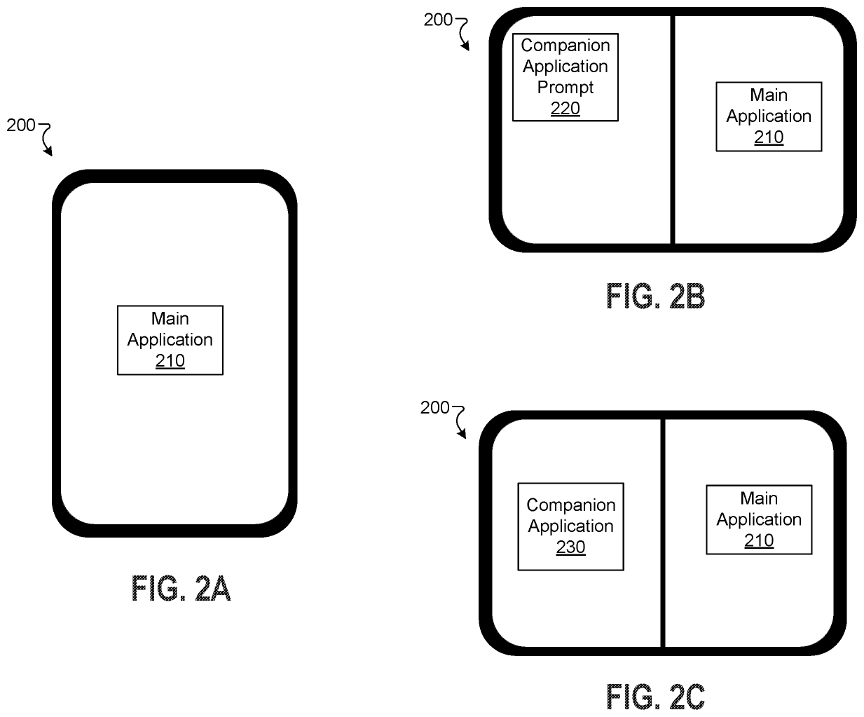

FIGS. 2A-2C are diagrams that illustrate an example triggering of a divided screen mode in a mobile device 200. The mobile device 200 can be in one of two modes that is defined by an aspect ratio of the screen: portrait or landscape. An aspect ratio is an example of a display aspect. When the mobile device 200 is rotated, the aspect ratio (i.e., a display aspect) of the mobile device 200 changes based on the mobile device 200 transitioning from the portrait mode to the landscape mode. In portrait mode, the screen is longer than it is wide; in landscape mode, the screen is wider than it is long. In a conventional mobile device, one application is displayed at a time, regardless of whether the mobile device 200 is in portrait mode or landscape mode. In FIG. 2A, the mobile device 200 is shown displaying a main application 210 in portrait mode.

FIG. 2B is a diagram that illustrates the mobile device 200 in landscape mode. When the mobile device 200 was switched from portrait mode to landscape mode, an indication was sent to processing circuitry of the mobile device 200. Upon receipt of the indication, the processing circuitry triggers a divided screen mode for the mobile device 200. In some implementations, the division is at or near the center of the screen of the mobile device 200. In some implementations, the division can be uneven. In some implementations, the division can be between the center of the screen and a quartile of the screen. On a first portion of the divided screen mode, an interface for the main application 210 is displayed. On a second portion of the divided screen mode, a selectable control, e.g., a prompt 220 for the companion application is displayed. In some implementations, the prompt 220 takes the form of an icon that, when touched by the user, launches the companion application 230.

FIG. 2C is a diagram that illustrates the mobile device 200 in the landscape mode, but with the prompt 220 having been replied to. Accordingly, the mobile device 200 is in the divided screen mode with the first portion displaying an interface for the main application 210 and the second portion displaying an interface for the companion application 230. In some implementations, the companion application 230 may be closed or sent to the background in response to the device 200 being changed from landscape mode to portrait mode.

In some implementations, the companion application 230 is configured to generate an input to be provided to the main application 210. In some implementations, the companion application 230 is configured to run a GAI model on the input to produce an output. In some implementations, the companion application runs as part of an operating system under which the main application 210 runs.

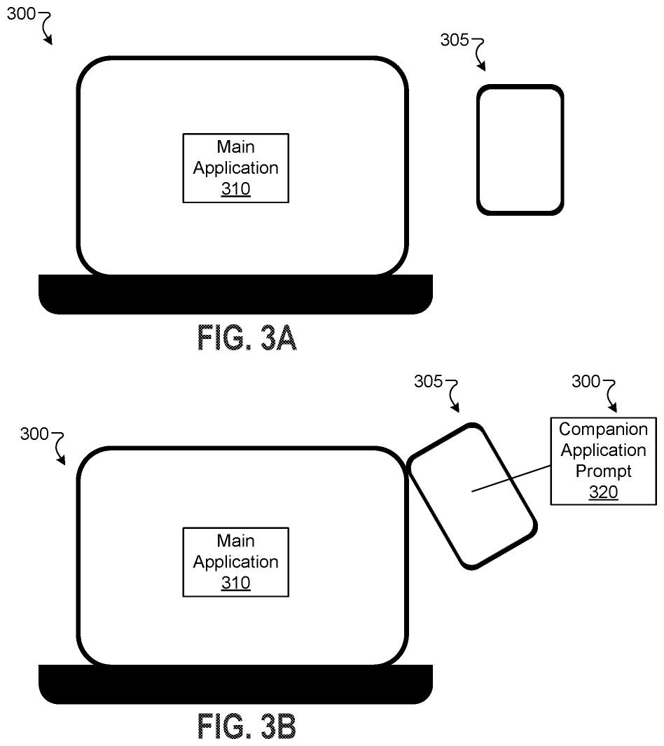

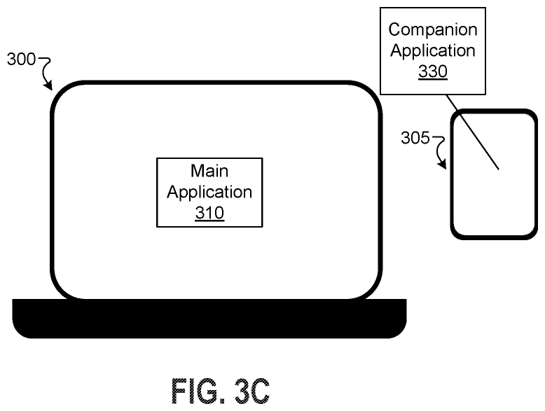

FIGS. 3A-3C are diagrams that illustrate an example triggering of a divided screen mode in a mobile device 305 via a personal computer 300. As shown in FIG. 3A, the desktop computer (or laptop, tablet computer, etc.) 300 displays an interface for a main application 310.

FIG. 3B is a diagram that illustrates a triggering of a divided screen mode between the personal computer 300 and the mobile device 305. In this case, the triggering is accomplished via an indication that the mobile device 305 has triggered a contact event with the monitor of the personal computer 300 via, e.g., a tap. The contact event is an example of a change in a display aspect. The indication is sent to processing circuitry of the desktop computer, and in response, the processing circuitry of the desktop computer sends a command to the mobile device 305 to display a selectable control, e.g., a prompt 320. That is, the indication makes the mobile device 305 a companion device to the personal computer 300. In some implementations, the mobile device 305 is paired with the personal computer 300 via a wireless link, e.g., a Bluetooth connection. Accordingly, the personal computer 300 and the mobile device 305 form a divided screen mode, with the personal computer 300 forming a first portion of the divided screen mode displaying an interface for the main application 310 and the mobile device 305 forming a second portion of the divided screen mode displaying a prompt 320 for the companion application 330.

FIG. 3C is a diagram that illustrates the divided screen mode for the personal computer 300 and the mobile device 305. In the divided screen mode, the first portion includes the screen of the personal computer 300, displaying an interface of the main application 310; the second portion includes the screen of the mobile device 305, displaying an interface of the companion application 330.

In some implementations, the companion application 330 is configured to generate an input to be provided to the main application 310. In some implementations, the companion application 330 is configured to run a GAI model on the input to produce an output. In some implementations, the output of the companion application 330 may be input back to the main application 310 by tapping the screen of the personal computer 300 with the mobile device 305.

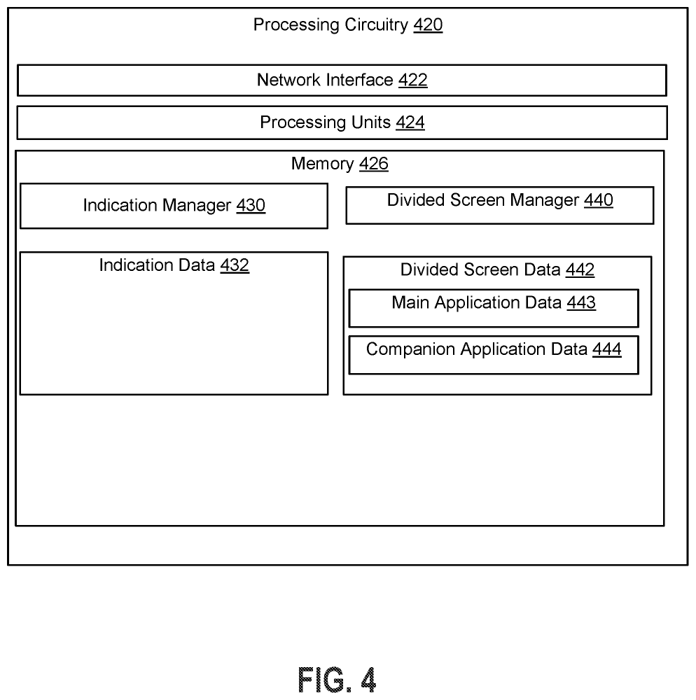

FIG. 4 is a diagram illustrating an example electronic environment for triggering a divided screen mode in response to an indication that a display aspect of a computing environment has changed. The processing circuitry 420 includes a network interface 422, one or more processing units 424, and nontransitory memory (storage medium) 426.

In some implementations, one or more of the components of the processing circuitry 420 can be, or can include processors (e.g., processing units 424) configured to process instructions stored in the memory 426 as a computer program product. Examples of such instructions as depicted in FIG. 4 include indication manager 430 and divided screen manager 440. Further, as illustrated in FIG. 4, the memory 426 is configured to store various data, which is described with respect to the respective services and managers that use such data.

The indication manager 430 is configured to receive an indication that a display aspect of a computing environment has changed, the computing environment including a display of a main application. The indication data 432 includes an expression of the indication sent to processing circuitry 420.

The divided screen manager 440 is configured to enter into a divided screen mode upon receipt of the indication data 432, as expressed in divided screen data 442. Divided screen data 442 includes main application data 443 and companion application data 444. In some implementations, the companion application data includes a selectable control (e.g., a prompt) associated with the companion application. In this case, the companion application is launched in response to the processing circuitry 420 receiving a selection of the selectable control.

The components (e.g., modules, processing units 424) of processing circuitry 420 can be configured to operate based on one or more platforms (e.g., one or more similar or different platforms) that can include one or more types of hardware, software, firmware, operating systems, runtime libraries, and/or so forth. In some implementations, the components of the processing circuitry 420 can be configured to operate within a cluster of devices (e.g., a server farm). In such an implementation, the functionality and processing of the components of the processing circuitry 420 can be distributed to several devices of the cluster of devices.

The components of the processing circuitry 420 can be, or can include, any type of hardware and/or software configured to process private data from a wearable device in a split-compute architecture. In some implementations, one or more portions of the components shown in the components of the processing circuitry 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 420 can be, or can include, a software module configured for execution by at least one processor (not shown) to cause the processor to perform a method as disclosed herein. In some implementations, the functionality of the components can be included in different modules and/or different components than those shown in FIG. 4, including combining functionality illustrated as two components into a single component.

The network interface 422 includes, for example, wireless adaptors, and the like, for converting electronic and/or optical signals received from the network to electronic form for use by the processing circuitry 420. The set of processing units 424 include one or more processing chips and/or assemblies. The memory 426 includes both volatile memory (e.g., RAM) and non-volatile memory, such as one or more ROMs, disk drives, solid state drives, and the like. The set of processing units 424 and the memory 426 together form processing circuitry, which is configured and arranged to carry out various methods and functions as described herein.

Although not shown, in some implementations, the components of the processing circuitry 420 (or portions thereof) can be configured to operate within, for example, a data center (e.g., a cloud computing environment), a computer system, one or more server/host devices, and/or so forth. In some implementations, the components of the processing circuitry 420 (or portions thereof) can be configured to operate within a network. Thus, the components of the processing circuitry 420 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 420 can be, or can include, processors configured to process instructions stored in a memory. For example, indication manager 430 (and/or a portion thereof) and divided screen manager 440 (and/or a portion thereof are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processing circuitry 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processing circuitry 420. As illustrated in FIG. 4, the memory 426 is configured to store various data, including indication data 432 and divided screen data 442.

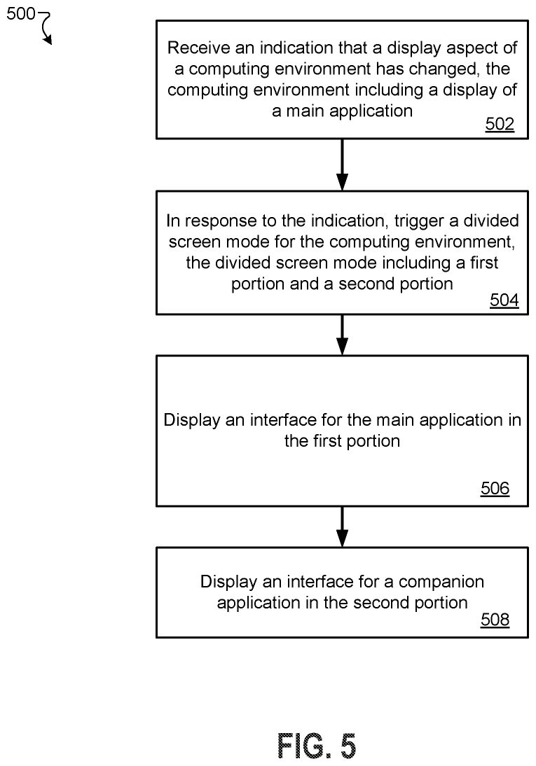

FIG. 5 is a flow chart illustrating an example method 500 for triggering a divided screen mode in a device. The method 500 may be performed using the processing circuitry 420 of FIG. 4.

At 502, the indication manager 430 receives an indication that a display aspect of a computing environment has changed, the computing environment including a display of a main application as described herein.

At 504, the divided screen manager 440, in response to the indication, triggers a divided screen mode for the computing environment, the divided screen mode including a first portion and a second portion as described herein.

At 506, the divided screen manager 440 displays an interface for the main application in the first portion as described herein.

At 508, the divided screen manager 440 displays an interface for the companion application in the second portion as described herein.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A method comprising:
receiving an indication that a display aspect of a computing environment has changed, the computing environment including a display of a main application; and
in response to receiving the indication:
triggering a divided screen mode for the computing environment, the divided screen mode including a first portion and a second portion,
displaying an interface for the main application in the first portion, and
launching a companion application in the second portion.

2. The method as in claim 1, wherein the companion application is configured to generate an input to be provided to the main application.

3. The method as in claim 2, wherein the companion application is configured to run a generative artificial intelligence model to produce an output for the input into the main application.

4. The method as in claim 3, wherein the companion application runs as part of an operating system.

5. The method as in claim 1, wherein the display aspect includes an aspect ratio.

6. The method as in claim 5, wherein the computing environment includes a foldable device, and the aspect ratio changes based on the foldable device transitioning from a folded mode to an open mode.

7. The method as in claim 5, wherein the computing environment includes a mobile device, and the aspect ratio changes based the mobile device transitioning from a portrait mode to a landscape mode.

8. The method as in claim 1, wherein the computing environment includes a personal computer and a mobile device, and receiving an indication that the display aspect has changed includes receiving a contact event that makes the mobile device a companion device, wherein the first portion is a display of the personal computer and the second portion is a display of the mobile device.

9. The method as in claim 1, further comprising, in response to the indication:
displaying a selectable control associated with the companion application; and
receiving selection of the selectable control,
wherein launching the companion application occurs in response to receiving the selection of the selectable control.

10. A computer program product comprising a non-transitory storage medium, the computer program product including code that, when executed by processing circuitry, causes the processing circuitry to perform a method, the method comprising:
receiving an indication that a display aspect of a computing environment has changed, the computing environment including a display of a main application; and
in response to receiving the indication:
triggering a divided screen mode for the computing environment, the divided screen mode including a first portion and a second portion,
displaying an interface for the main application in the first portion, and
launching a companion application in the second portion.

11. The computer program product as in claim 10, wherein the companion application is configured to generate an input to be provided to the main application.

12. The computer program product as in claim 11, wherein the companion application is configured to run a generative artificial intelligence model to produce an output for the input into the main application.

13. The computer program product as in claim 12, wherein the companion application runs as part of an operating system.

14. The computer program product as in claim 10, wherein the display aspect includes an aspect ratio.

15. The computer program product as in claim 14, wherein the computing environment includes a foldable device, and the aspect ratio changes based on the foldable device transitioning from a folded mode to open mode.

16. The computer program product as in claim 14, wherein the computing environment includes a mobile device, and the aspect ratio changes based the mobile device transitioning from a portrait mode to a landscape mode.

17. The computer program product as in claim 10, wherein the computing environment includes a personal computer and a mobile device, and receiving an indication that the display aspect has changed includes receiving a contact event that makes the mobile device a companion device, wherein the first portion is a display of the personal computer and the second portion is a display of the mobile device.

18. The computer program product as in claim 10, wherein the method further comprises, in response to the indication:
displaying a selectable control associated with the companion application; and
receiving selection of the selectable control,
wherein launching the companion application occurs in response to receiving the selection of the selectable control.

19. An electronic apparatus, the electronic apparatus comprising:
memory; and
processing circuitry coupled to the memory, the processing circuitry being configured to:
receive an indication that a display aspect of a computing environment has changed, the computing environment including a display of a main application; and
in response to receiving the indication:
trigger a divided screen mode for the computing environment, the divided screen mode including a first portion and a second portion,
display an interface for the main application in the first portion,
display a selectable control associated with a companion application, wherein the companion application is configured to generate an input to be provided to the main application,
receive selection of the selectable control, and
in response to receiving the selection of the selectable control, initiate a display of an interface for the companion application in the second portion.

20. (canceled)

21. The electronic apparatus as in claim 19, wherein the companion application is configured to run a generative artificial intelligence model on the input to produce an output.

22. The electronic apparatus as in claim 21, wherein the companion application runs as part of an operating system under which the main application runs.

23. The electronic apparatus as in claim 19, wherein the electronic apparatus includes a foldable device, the display aspect includes an aspect ratio and wherein the aspect ratio changes based on the foldable device transitioning from a folded mode to an open mode.
